(19) United States
(12) Patent Application Publication
(10) Pub. No.: US 2003/0148536 A1
(43) Pub. Date: Aug. 7, 2003

(54) Chemiluminescence analyzer

(76) Inventors: Chi-Wang Liang, Chung Ho City (TW); Jeng-Fong Chiou, Taipei (TW)

Correspondence Address: FISH & RICHARDSON PC, 225 FRANKLIN ST, BOSTON, MA, 02110, US

(21) Appl. No.: 10/067,501

(22) Filed: Feb. 4, 2002

(51) Int. Cl. G01N 21/76

(52) U.S. Cl. 436/172; 436/164; 422/52; 422/82.05; 422/82.08; 250/458.1; 250/459.1

(57) ABSTRACT

A chemiluminescence analyzer determines the level of chemiluminescence of a specimen. The chemiluminescence analyzer includes a light detection chamber for containing the specimen to be analyzed. The light detection chamber includes a chamber access device, for allowing the positioning of the specimen within the light detection chamber, and a shutter device. The shutter device and the chamber access device are configured to each have an open position and a closed position. A light detector is positioned behind the shutter device. When the shutter device is in the open position, the light detector detects light within the light detection chamber. An interlock assembly is interfaced with the shutter device and the chamber access device, such that the interlock assembly prevents the shutter device and the chamber access device from being simultaneously opened.

### TECHNICAL FIELD

This invention relates to chemiluminescence analyzers.

### BACKGROUND

Energy transfer in matter can occur in many different ways, such as heat, light, and chemical reactions. Light emission is known as luminescence and is a basic phenomenon of biology, chemistry, and physics. When this light emission is the result of a chemical reaction, the process is called chemiluminescence.

Low-level chemiluminescence exits in most biological systems and occurs in response to environmental changes in the system in which a biological organism lives. There exists in all living things a low-level photon emission (in the frequency range of 180-800 nanometers and the intensity range of 10-10,000 photons per second per square centimeter) that is related to oxidative metabolism, detoxification reactions, cell division, cell death, photosynthesis, carcinogens, and the regulation of growth.

In recent years, biologists and medical scientists have used chemiluminescence to aid in biological studies and medical diagnoses. Additionally, chemiluminescence technology can be used in other areas, such as determining the effect of environmental pollution on living organisms, and determining the level of ripeness/freshness of fruits and vegetables, for example.

### SUMMARY

The invention relates to a device useful for analyzing or measuring energy transfer. The device is useful for determining chemiluminescence processes and is thereby useful for analyzing samples (e.g., organisms, cells, chemicals). Chemiluminescence processes are indicative of particular states or changes in the sample.

According to an aspect of this invention, a chemiluminescence analyzer determines the level of chemiluminescence of a specimen. The chemiluminescence analyzer includes a light detection chamber for containing the specimen to be analyzed. The light detection chamber includes a chamber access device, for allowing the positioning of the specimen within the light detection chamber, and a shutter device. The shutter device and the chamber access device are configured to each have an open position and a closed position. A light detector is positioned behind the shutter device. When the shutter device is in the open position, the light detector detects light within the light detection chamber. An interlock assembly is interfaced with the shutter device and the chamber access device, such that the interlock assembly prevents the shutter device and the chamber access device from being simultaneously opened.

One or more of the following features may also be included. The light detector is a photomultiplier tube which generates a chemiluminescence intensity signal indicative of the level of chemiluminescence of the specimen positioned within the light detection chamber. The chemiluminescence analyzer further includes a signal processing controller for processing the chemiluminescence intensity signal to generate output data useable by an external device. The external device is a personal computer that stores the output data. The personal computer includes a data presentation process for analyzing the output data and presenting it to the user of the chemiluminescence analyzer in a graphical or tabular format. The chemiluminescence intensity signal is a current-based signal. The output data is a digital signal indicative of the level of chemiluminescence of the specimen positioned within the light detection chamber. The signal processing controller is a current-to-pulse frequency transformer circuit. The photomultiplier tube is either a head-on photomultiplier tube that senses the level of chemiluminescence through an end of the photomultiplier tube, or a side-on photomultiplier tube that senses the level of chemiluminescence through a side of the photomultiplier tube.

The chemiluminescence analyzer further includes a temperature control system for maintaining the ambient temperature within the light detection chamber at a predefined level. The predefined level is a user defined level and the temperature control system includes a thermostat for allowing the user of the chemiluminescence analyzer to specify the user defined level. The temperature control system includes an electric heating device, responsive to the thermostat, for maintaining the ambient temperature within the light detection chamber at the predefined level.

The chamber access device is a specimen drawer into which the specimen is placed. The specimen drawer is configured to slide into the light detection chamber, thus minimizing the intrusion of light into the light detection chamber. Alternatively, the chamber access device is an openable lid through which the specimen is positioned within the light detection chamber. The openable lid is configured to minimize the intrusion of light into the light detection chamber when the openable lid is in a closed position.

The interlock assembly is a mechanical interlock assembly which includes one or more mechanical linkages for mechanically interconnecting the shutter device and the chamber access device to prevent the shutter device and the chamber access device from simultaneously being in the open position. Alternatively, the interlock assembly is an electrical interlock assembly which includes one or more solenoid devices for electrically interfacing the shutter device and the chamber access device to prevent the shutter device and the chamber access device from simultaneously being in the open position.

According to a further aspect of this invention, a method for determining the level of chemiluminescence of a specimen includes positioning the specimen within a light detection chamber. A light detector is positioned behind a shutter incorporated into the light detection chamber. The shutter is opened to allow the light detector to detect light within the light detection chamber. A chemiluminescence intensity signal is generated that is indicative of the level of chemiluminescence of the specimen positioned within the light detection chamber. The shutter device and the chamber access device are interfaced to prevent them from being simultaneously opened.

One or more of the following features may also be included. The method further includes processing the chemiluminescence intensity signal to generate output data useable by an external device. The method further includes analyzing the output data and presenting the output data to the user of the chemiluminescence analyzer in a graphical or tabular format. The method further includes maintaining the ambient temperature within the light detection chamber at a predefined level. The predefined level is a user defined level. The method further includes allowing the user of the chemiluminescence analyzer to specify the user defined level. The method further includes minimizing the intrusion of light into the light detection chamber.

Interfacing the shutter device and the chamber access device includes mechanically interconnecting the shutter device and the chamber access device with one or more mechanical linkages to prevent them from being simultaneously opened. Alternatively, interfacing the shutter device and the chamber access device includes electrically interfacing the shutter device and the chamber access device with one or more solenoid devices to prevent them from being simultaneously opened.

One or more advantages can be provided from the above aspects of the invention. A chemiluminescence analyzer is achievable that provides a high level of sensitivity to chemiluminescence generated by a specimen. By interfacing the shutter device and the chamber access device, light detector overloading can be eliminated. Further, chemiluminescence sensitivity is enhanced through the use of a temperature control system. Additionally, storing the data related to the chemiluminescence of the specimen on a computer system allows for retrieval and analysis at a later date. Moreover, this computer system can present this data to the user is graphical or tabular form.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagrammatic view of a chemiluminescence analyzer according to this invention;

FIG. 2 is a detail view of the drawer seal according to this invention;

FIG. 3 is a detail view of the photomultiplier tube according to this invention;

FIG. 4 is a detail view of a mechanical interfacing embodiment according to this invention;

FIG. 5 is a detail view of the computer system according to this invention;

FIG. 6 is a detail view of an electrical interfacing embodiment according to this invention; and

FIG. 7 is a flow chart showing a method for determining the level of chemiluminescence of a specimen according to this invention;

Like reference symbols in the various drawings indicate like elements.

### DETAILED DESCRIPTION

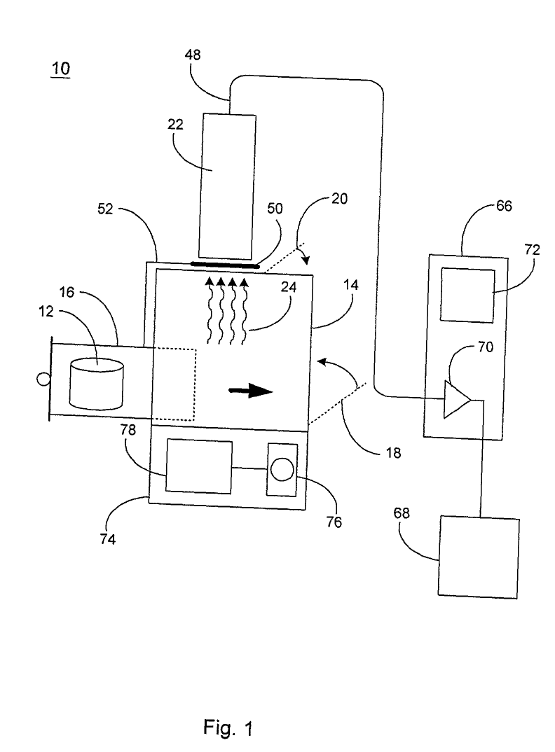

Referring to FIG. 1, a chemiluminescence analyzer 10 determines the level of chemiluminescence of a specimen 12. Examples of specimen 12 are blood, urine, and cells. Chemiluminescence analyzer 10 includes a light detection chamber 14 for housing the specimen to be analyzed. Light detection chamber 14 includes a drawer 16 into which the specimen 12 to be analyzed is placed. This allows the user of chemiluminescence analyzer 10 to position sample 12 within chamber 14.

A photomultiplier tube 22, which is positioned proximate light detection chamber 14, detects photons of light 24 emitted from specimen 12. As stated above, this low-level photon emission (i.e., chemiluminescence) occurs for all livings things. Therefore, whenever a living biological specimen is placed into drawer 16 and draw 16 is closed, photomultiplier tube 22 will sense a low-level emission of photons 24.

Since the level of photon emission and, therefore, the light intensity within light detection chamber 14 is very low, it is important that drawer 16 seals sufficiently against chamber 14 so that a “light proof” seal is created which essentially seals off the interior of chamber 14 from any light or light source that is external to chamber 14.

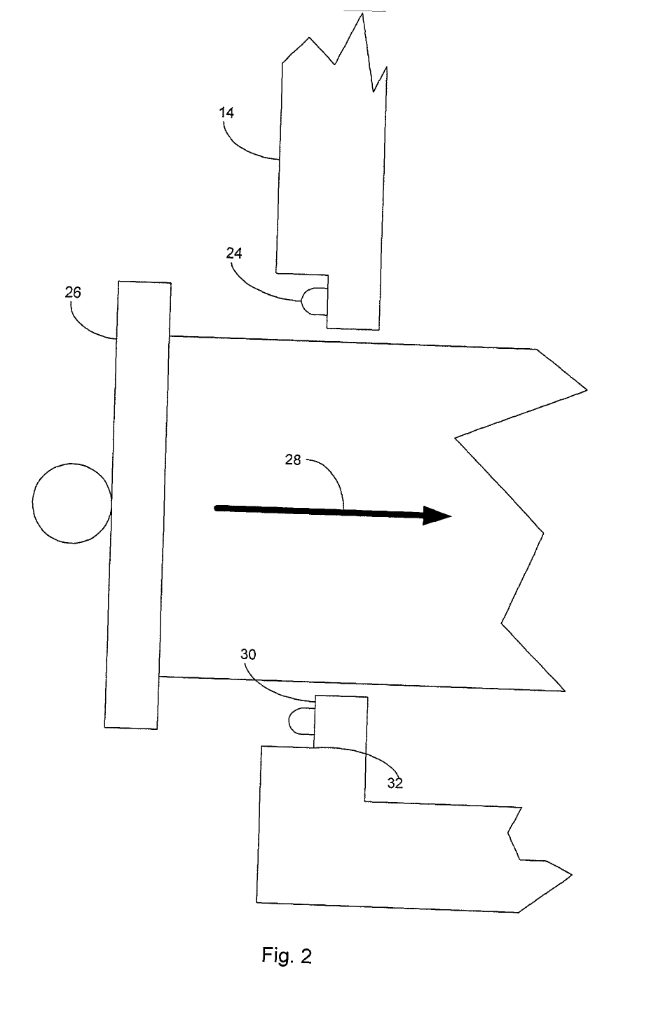

Referring to FIGS. 1 and 2, a seal 24 (e.g., a rubber gasket) typically surrounds drawer front 26 of drawer 16 so that when drawer 16 is slid (in the direction of arrow 28) into light detection chamber 14, seal 24 contacts the back of drawer front 26 and forms a seal which eliminates (or minimizes) the intrusion of external light into chamber 14. The sealing ability of seal 24 may be enhanced by designing the drawer front 26 so that it tightly engages the recess 30 into which drawer front 26 slides. Further, by incorporating right angles into recess 30 (such as right angle 32), the possibility of light intrusion into chamber 14 is further reduced.

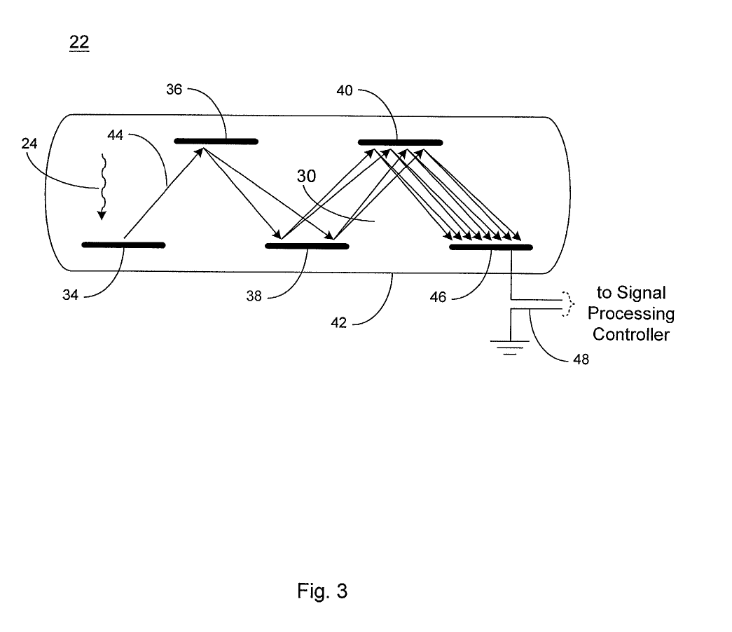

Referring to FIGS. 1 and 3, photomultiplier tube 22 typically includes a photocathode 34 and multiple dynodes 36, 38, 40, in an glass enclosure 42. When a photon 24 of sufficient energy is emitted from specimen 12 and strikes photocathode 34, a photoelectron 44 is ejected from photocathode 34 as a result of the photoelectric effect. This photocathode 34 is usually constructed of alkali metals, which make the photomultiplier tube sensitive to photons in the visible region of the electromagnetic spectrum. A high negative voltage (e.g., −500 to −1500 volts) is applied to photocathode 34. The dynodes incorporated into photomultiplier tube 22 are each successively held at a less negative potential. Accordingly, photoelectron 44 is accelerated toward this series of dynodes. As each one of these photoelectrons strikes a dynode, multiple photoelectrons are generated and accelerated toward the next dynode in the series, resulting in a cascading photoelectron multiplication effect. This multiplication effect is very high and typically results in 100,000 to 10,000,000 photoelectrons striking the anode 46 for each photoelectron initially striking photocathode 34. This results in anode 46 generating a chemiluminescence intensity signal (typically a current-based signal) on line 48 that is indicative of the level of chemiluminescence of specimen 12.

As the intensity of the light emitted due to chemiluminescence (i.e., the number of photons emitted) is very low, photomultiplier tube 22 should be highly sensitive to light. Photomultiplier tube 22 typically has a sensitivity of 8˜15 μA/lm per photon of incident light. A typical embodiment of such a photomultiplier tube is a model CR120 offered by The Hamamatsu Corporation of Japan.

Photomultiplier tube 22 may be a “head-on” type photomultiplier tube that detects photons 24 through the end of glass enclosure 42. Alternatively, photomultiplier tube 22 may be a “side-on” type photomultiplier tube that detects photons 24 through the side of glass enclosure 42.

Chemiluminescence analyzer 10 includes a shutter 50 positioned between photomultiplier tube 22 and light detection chamber 14. Shutter 50, which is similar in design to the shutter of a camera and can be in either an opened or a closed position, is configured to close when drawer 16 is opened. As described above, photomultiplier tube 22 is very sensitive to light, as it is designed to sense very low-level light emission. Whenever drawer 16 is opened, the interior of chamber 14 is flooded with light. This would result in photomultiplier tube 22 being overloaded and possibly damaged. Accordingly, chemiluminescence analyzer 10 includes an interlock assembly 52 which interfaces shutter 50 and drawer 16 so that both of these devices cannot be opened simultaneously.

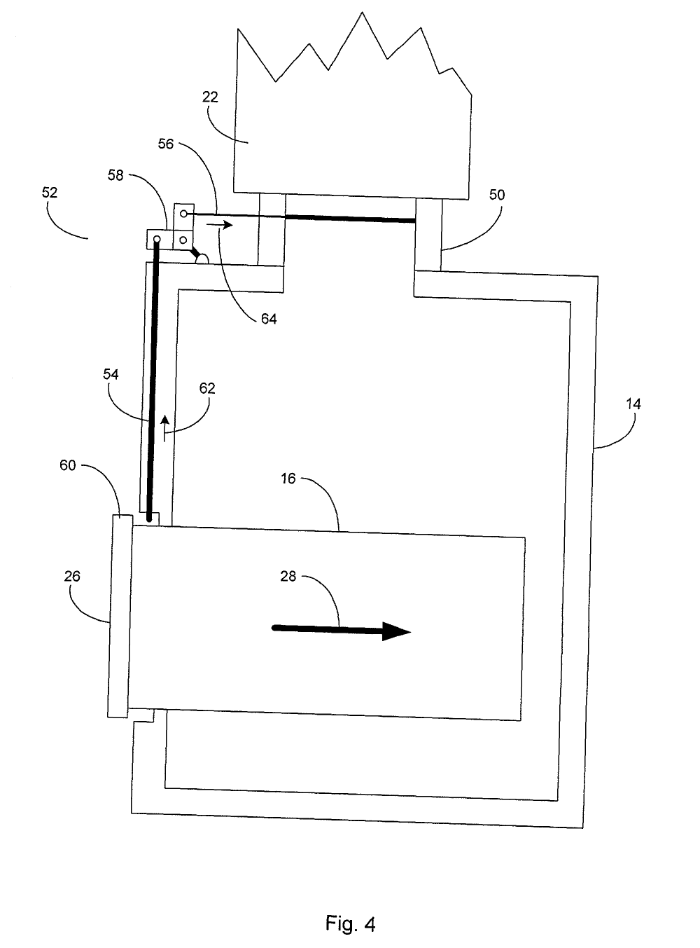

Referring to FIGS. 1 and 4, the details of a particular embodiment of interlock assembly 52 are shown. Interlock assembly 52 typically includes one or more mechanical linkages which mechanically interconnect shutter 50 and drawer 16. Interlock assembly 52 is designed to prevent shutter device 50 and drawer 16 from being simultaneously opened. Please realize that the following example is for illustrative purposes only and displays only one possible mechanical embodiment of interlock assembly 52. It is not intended to represent the only embodiment and is not intended to be a limitation of the invention.

This embodiment of interlock assembly 52 includes a pair of mechanical linkage rods 54 and 56 and a bell crank assembly 58. During use of chemiluminescence analyzer 10, specimen 12 is placed in drawer 16 and drawer 16 is slide into light detection chamber 14 in the direction of arrow 28. When drawer 16 is fully closed (i.e. fully inserted in light detection chamber 14), the upper edge 60 of drawer front 26 contacts linkage rod 54, resulting in linkage rod 54 moving in the direction of arrow 62. This movement of linkage rod 54 results in bell crank 58 rotating clockwise. This clockwise rotation of bell crank 58 moves linkage rod 56 in the direction of arrow 64. This movement of linkage rod 56, which is attached to the actuator rod (not shown) of shutter 50, results in shutter 50 opening, thus allowing photomultiplier tube 22 to detect light within light detection chamber 14. Conversely, if drawer 16 is opened, shutter 50 is closed via linkage rods 54 and 56 and bell crank 58, thus preventing the shutter 50 and drawer 16 from being simultaneously opened.

The output of photomultiplier tube 22 (i.e., the chemiluminescence intensity signal on line 48) is provided to a signal processing controller 66 that converts this output signal to a signal (i.e. output data) usable by a computer 68. Computer 68 is a device that accepts information (in the form of digital data) and manipulates it for some result based on a program or sequence of instructions concerning how the data is to be processed. The output data generated by signal processing controller 66 is typically a digital signal that is provided to computer 68 via a communication port (not shown), an Ethernet card (not shown) or some other form of peripheral card (not shown) installed in computer 68. Signal processing controller 66 may include an amplifier circuit 70 for amplifying the chemiluminescence intensity signal to a useable level.

As stated above, the chemiluminescence intensity signal is typically a variable current that is indicative of the level of chemiluminescence of specimen 12. Accordingly, if the chemiluminescence intensity signal is indeed a current, signal processing controller 66 includes a current-to-pulse frequency transformer circuit 72 which converts the current-based chemiluminescence intensity signal to digital output data. A typical current-to-pulse frequency transformer circuit has an input range of 1×10⁻¹¹˜1×10⁻⁶ amps, and provides 22,000 pulses per second for an input of 1.0×10⁻⁷ amps.

As is known, chemiluminescence activity decreases as temperature drops. Accordingly, it is desirable to maintain specimen 12 at no less than a defined minimum working temperature. This minimum working temperature is typically 4° C. Chemiluminescence analyzer 10 includes a temperature control system 74 for maintaining light detection chamber 14 and, therefore, specimen 12, at a specified ambient temperature that is greater than or equal to the minimum working temperature. This specified ambient temperature is typically settable by the user of chemiluminescence analyzer 10. Accordingly, temperature control system 74 includes a thermostat 76 for allowing the user to set this specified ambient temperature. Temperature control system 74 includes a heating device 78 that is responsive to thermostat 76 and generates the heat required to maintain the specified ambient temperature. This heating device 78 may be powered by electricity, natural gas, propane, etc.

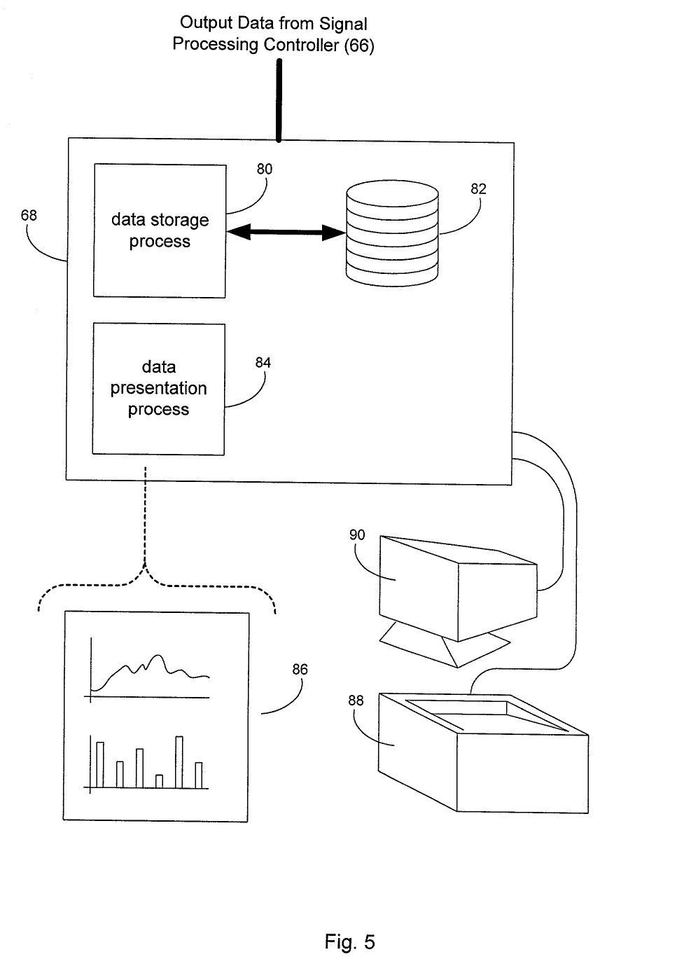

Referring to FIGS. 1 and 5, computer 68 executes a data storage process 80 that stores the output data, which is provided by signal processing controller 66, on a storage device 82. This storage device 82 may be a local hard drive, a network hard drive mounted in a remote network server (not shown), or any other forms of storage device (e.g., tape drive, RAID array, RAM, optical drive, etc.). Storage device 82 may be later accessed by the user to retrieve the output data stored on it. Additionally, as storage process 80 may be configured to be an automatic process, user interaction would not be required and data storage process 80 can continuously record output data over an extended period of time, thus allowing for extended measurement periods.

Computer 68 also includes and executes a data presentation process 84 which analyzes the output data provided by signal processing controller 66 and presents this data to the user of chemiluminescence analyzer 10. This output data may be presented to the user as a report 86 in the form of graphics, tables, text, video, audio, or any combination of the five. These reports 86 are presented to the user via a printer 88 and/or a monitor 90, each of which is attached to computer 68. Additionally, if report 86 includes audio, some form of speaker (not shown) must be used.

Alternative Embodiments:

Referring to FIG. 1, while chemiluminescence analyzer 10 is described above as including a drawer 16 into which specimen 12 is placed, this is for illustrative purposes only and is not intended to be a limitation of the invention. For example, drawer 16 is but one example of the various types of chamber access devices that may be employed. Specifically, some form of openable door 18 (shown in phantom) or openable lid 20 (shown in phantom) may be incorporated into light detection chamber 14 so that the user can position specimen 12 within the chamber for analysis.

While chemiluminescence analyzer 10 is described above as including a photomultiplier tube 22 as a light detector, this is only one example of the various forms of light detectors that may be used. An example of an alternative light detector is a bioluminometer.

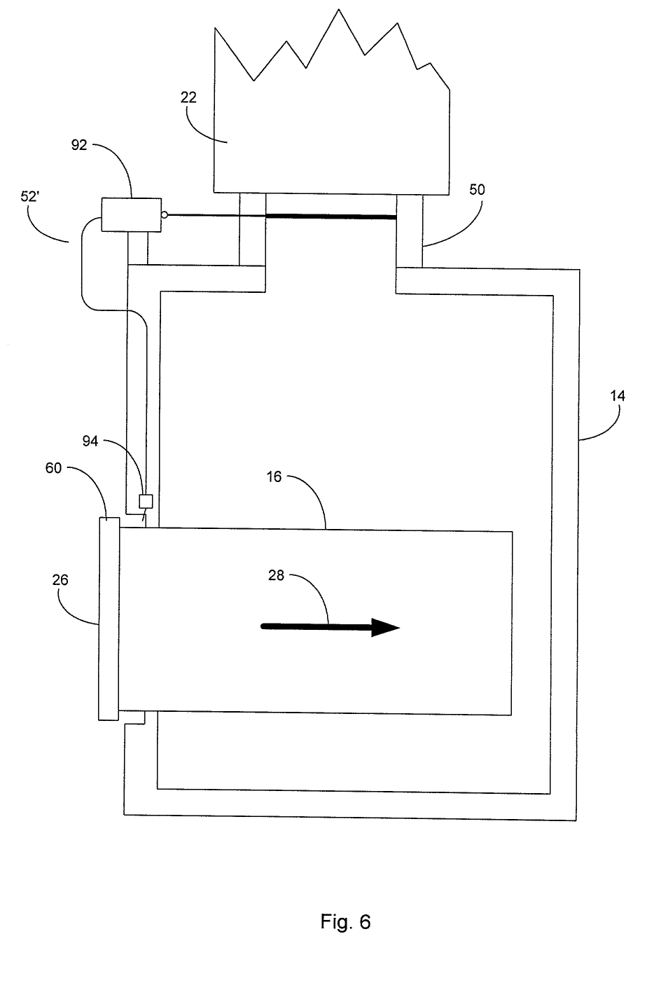

While interlock assembly 52 is shown as being a mechanical interlock assembly, this is for illustrative purposes only. Referring to FIGS. 1 and 6, the details of an electrical embodiment of interlock assembly 52′ are shown. Interlock assembly 52′ typically includes one or more solenoids which electrically interconnect shutter 50 and drawer 16. While a solenoid is shown, this is but one example of an electrical actuation device and is not intended to be a limitation of the invention. Other examples include electric motors or any other device capable of converting an electrical signal to mechanical actuation.

Interlock assembly 52′ is designed to prevent shutter device 50 and drawer 16 from being simultaneously opened. Please realize that the following example is for illustrative purposes only and displays only one possible electrical embodiment of interlock assembly 52′. It is not intended to represent the only embodiment and is not intended to be a limitation of the invention.

This embodiment of interlock assembly 52′ includes a single solenoid 92 and a switch assembly 94 which controls solenoid 92. During use of chemiluminescence analyzer 10, a specimen 12 is placed in drawer 16 and drawer 16 is slid into light detection chamber 14 in the direction of arrow 28. When drawer 16 is fully closed (i.e. fully inserted in light detection chamber 14), the upper edge 60 of drawer front 26 will contact switch 94, resulting in solenoid 92 being energized and shutter 50 opening. This allows photomultiplier tube 22 to detect light within light detection chamber 14. Conversely, if drawer 16 is opened, switch 94 is opened, deenergizing solenoid 92 and closing shutter 50. Accordingly, this prevents the shutter 50 and drawer 16 from being simultaneously opened.

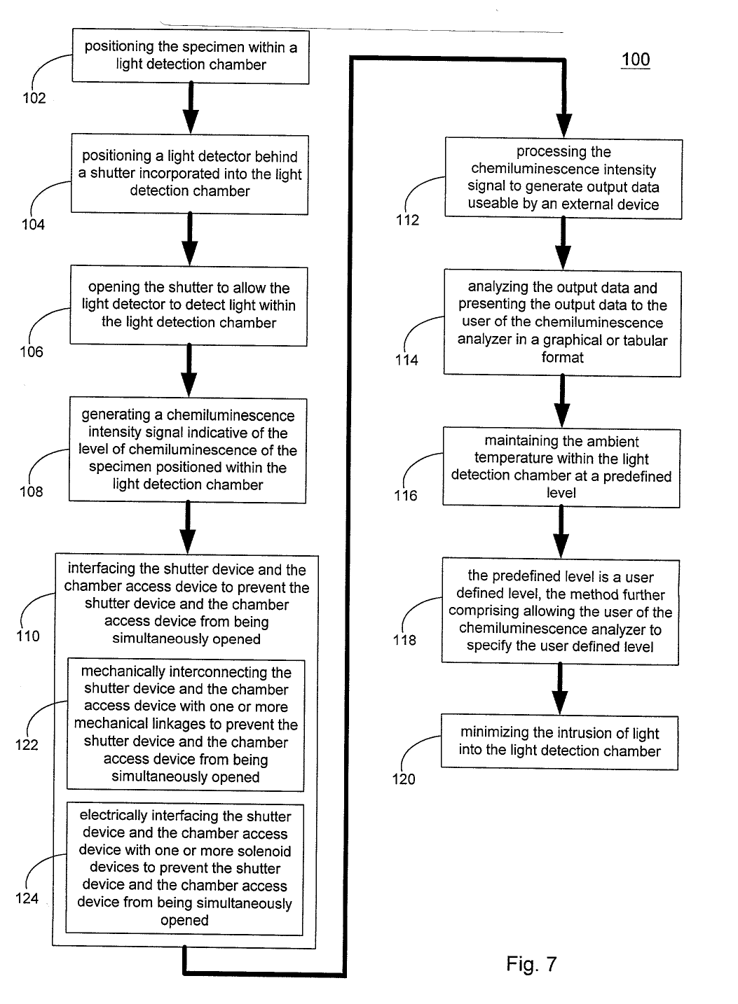

Referring to FIG. 7, there is shown a method 100 for determining the level of chemiluminescence of a specimen. The specimen is positioned 102 within the light detection chamber. A light detector is positioned 104 behind a shutter incorporated into the light detection chamber. The shutter is opened 106 to allow the light detector to detect light within the light detection chamber. A chemiluminescence intensity signal is generated 108 that is indicative of the level of chemiluminescence of the specimen positioned within the light detection chamber. The shutter device and the chamber access device are interfaced 110 to prevent the shutter device and the chamber access device from being simultaneously opened.

The chemiluminescence intensity signal is processed 112 to generate output data useable by an external device. The output data is analyzed and presented 114 to the user of the chemiluminescence analyzer in a graphical or tabular format. The ambient temperature within the light detection chamber is maintained 116 at a predefined level. The predefined level is a user defined level and the user of the chemiluminescence analyzer is allowed 118 to specify the user defined level. The intrusion of light into the light detection chamber is minimized 120.

Interfacing 110 the shutter device and the chamber access device includes mechanically interconnecting 122 the shutter device and the chamber access device with one or more mechanical linkages to prevent the shutter device and the chamber access device from being simultaneously opened. Alternatively, interfacing 110 the shutter device and the chamber access device includes electrically interfacing 124 the shutter device and the chamber access device with one or more solenoid devices to prevent the shutter device and the chamber access device from being simultaneously opened.

A number of embodiments of the invention have been described. Nevertheless, it will be understood that various modifications may be made without departing from the spirit and scope of the invention.

What is claimed is:

1. A chemiluminescence analyzer for determining the level of chemiluminescence of a specimen comprising:
a light detection chamber for containing a specimen to be analyzed, said light detection chamber including a chamber access device for allowing the positioning of the specimen within said light detection chamber, said light detection chamber further including a shutter device, wherein said shutter device and said chamber access device are configured to each have an open position and a closed position;
a light detector, positioned behind said shutter device, for detecting light within said light detection chamber when said shutter device is in said open position; and
an interlock assembly, interfaced with said shutter device and said chamber access device, for preventing said shutter device and said chamber access device from simultaneously being in said open position.

2. The chemiluminescence analyzer of claim 1 wherein said light detector is a photomultiplier tube which generates a chemiluminescence intensity signal indicative of the level of chemiluminescence of the specimen positioned within said light detection chamber.

3. The chemiluminescence analyzer of claim 2 further comprising a signal processing controller for processing said chemiluminescence intensity signal to generate output data useable by an external device.

4. The chemiluminescence analyzer of claim 3 wherein said external device is a personal computer for storing said output data, said personal computer including a data presentation process for analyzing said output data and presenting said output data to the user of said chemiluminescence analyzer in a graphical or tabular format.

5. The chemiluminescence analyzer of claim 3 wherein said chemiluminescence intensity signal is a current-based signal, said output data is a digital signal indicative of the level of chemiluminescence of the specimen positioned within said light detection chamber, and said signal processing controller is a current-to-pulse frequency transformer circuit.

6. The chemiluminescence analyzer of claim 2 wherein said photomultiplier tube is a head-on photomultiplier tube which senses the level of chemiluminescence through an end of said photomultiplier tube.

7. The chemiluminescence analyzer of claim 2 wherein said photomultiplier tube is a side-on photomultiplier tube which senses the level of chemiluminescence through a side of said photomultiplier tube.

8. The chemiluminescence analyzer of claim 1 further comprising a temperature control system for maintaining the ambient temperature within said light detection chamber at a predefined level.

9. The chemiluminescence analyzer of claim 8 wherein said predefined level is a user defined level and said temperature control system includes a thermostat for allowing the user of said chemiluminescence analyzer to specify said user defined level.

10. The chemiluminescence analyzer of claim 9 wherein said temperature control system includes an electric heating device, responsive to said thermostat, for maintaining the ambient temperature within said light detection chamber at said predefined level.

11. The chemiluminescence analyzer of claim 1 wherein said chamber access device is a specimen drawer into which the specimen is placed, said specimen drawer being configured to slide into said light detection chamber, thus minimizing the intrusion of light into said light detection chamber.

12. The chemiluminescence analyzer of claim 1 wherein said chamber access device is an openable lid through which said specimen is positioned within said light detection chamber, said openable lid being configured to minimize the intrusion of light into said light detection chamber when said openable lid is in a closed position.

13. The chemiluminescence analyzer of claim 1 wherein said interlock assembly is a mechanical interlock assembly which includes one or more mechanical linkages for mechanically interconnecting said shutter device and said chamber access device to prevent said shutter device and said chamber access device from simultaneously being in said open position.

14. The chemiluminescence analyzer of claim 1 wherein said interlock assembly is an electrical interlock assembly which includes one or more electrical actuation devices for electrically interfacing said shutter device and said chamber access device to prevent said shutter device and said chamber access device from simultaneously being in said open position.

15. A chemiluminescence analyzer for determining the level of chemiluminescence of a specimen comprising:
a light detection chamber for containing a specimen to be analyzed, said light detection chamber including a chamber access device for allowing the positioning of the specimen within said light detection chamber, said light detection chamber further including a shutter device, wherein said shutter device and said chamber access device are configured to each have an open position and a closed position; and
a photomultiplier tube, positioned behind said shutter device, for detecting light within said light detection chamber when said shutter device is in said open position, said photomultiplier tube being configured to generate a chemiluminescence intensity signal indicative of the level of chemiluminescence of the specimen positioned within said light detection chamber.

16. The chemiluminescence analyzer of claim 15 further comprising an interlock assembly, interfaced with said shutter device and said chamber access device, for preventing said shutter device and said chamber access device from simultaneously being in said open position.

17. The chemiluminescence analyzer of claim 15 further comprising a signal processing controller for processing said chemiluminescence intensity signal to generate output data useable by an external device.

18. The chemiluminescence analyzer of claim 17 wherein said external device is a personal computer for storing said output data, said personal computer including a data presentation process for analyzing said output data and presenting said output data to the user of said chemiluminescence analyzer in a graphical or tabular format.

19. The chemiluminescence analyzer of claim 15 wherein said photomultiplier tube is a head-on photomultiplier tube which senses the level of chemiluminescence through an end of said photomultiplier tube.

20. The chemiluminescence analyzer of claim 15 wherein said photomultiplier tube is a side-on photomultiplier tube which senses the level of chemiluminescence through a side of said photomultiplier tube.

21. A chemiluminescence analyzer for determining the level of chemiluminescence of a specimen comprising:
a light detection chamber for containing a specimen to be analyzed, said light detection chamber including a chamber access device for allowing the positioning of the specimen within said light detection chamber, said light detection chamber further including a shutter device, wherein said shutter device and said chamber access device are configured to each have an open position and a closed position;
a light detector, positioned behind said shutter device, for detecting light within said light detection chamber when said shutter device is in said open position, said light detector being configured to generate a current-based chemiluminescence intensity signal indicative of the level of chemiluminescence of the specimen positioned within said light detection chamber;
a current-to-pulse frequency transformer circuit for processing said current-based chemiluminescence intensity signal to generate a digital output data signal indicative of the level of chemiluminescence of the specimen positioned within said light detection chamber; and
a personal computer for storing the output data encoded within said digital output data signal, said personal computer including a data presentation process for analyzing said output data and presenting said output data to the user of said chemiluminescence analyzer in a graphical or tabular format.

22. The chemiluminescence analyzer of claim 21 further comprising an interlock assembly, interfaced with said shutter device and said chamber access device, for preventing said shutter device and said chamber access device from simultaneously being in said open position.

23. A chemiluminescence analyzer for determining the level of chemiluminescence of a specimen comprising:
a light detection chamber for containing a specimen to be analyzed, said light detection chamber including a chamber access device for allowing the positioning of the specimen within said light detection chamber, said light detection chamber further including a shutter device, wherein said shutter device and said chamber access device are configured to each have an open position and a closed position;
a light detector, positioned behind said shutter device, for detecting light within said light detection chamber when said shutter device is in said open position; and
a temperature control system for maintaining the ambient temperature within said light detection chamber at a predefined level.

24. The chemiluminescence analyzer of claim 23 wherein said predefined level is a user defined level and said temperature control system includes a thermostat for allowing the user of said chemiluminescence analyzer to specify said user defined level.

25. The chemiluminescence analyzer of claim 24 wherein said temperature control system includes an electric heating device, responsive to said thermostat, for maintaining the ambient temperature within said light detection chamber at said predefined level.

26. The chemiluminescence analyzer of claim 23 further comprising an interlock assembly, interfaced with said shutter device and said chamber access device, for preventing said shutter device and said chamber access device from simultaneously being in said open position.

27. A method for determining the level of chemiluminescence of a specimen comprising:
positioning the specimen within a light detection chamber;
positioning a light detector behind a shutter incorporated into the light detection chamber;
opening the shutter to allow the light detector to detect light within the light detection chamber;
generating a chemiluminescence intensity signal indicative of the level of chemiluminescence of the specimen positioned within the light detection chamber; and
interfacing the shutter device and the chamber access device to prevent the shutter device and the chamber access device from being simultaneously opened.

28. The method of claim 27 further comprising processing the chemiluminescence intensity signal to generate output data useable by an external device.

29. The method of claim 28 further comprising analyzing the output data and presenting the output data to the user of the chemiluminescence analyzer in a graphical or tabular format.

30. The method of claim 27 further comprising maintaining the ambient temperature within the light detection chamber at a predefined level.

31. The method of claim 30 wherein the predefined level is a user defined level, said method further comprising allowing the user of the chemiluminescence analyzer to specify the user defined level.

32. The method of claim 27 further comprising minimizing the intrusion of light into the light detection chamber.

33. The method of claim 27 wherein said interfacing the shutter device and the chamber access device includes mechanically interconnecting the shutter device and the chamber access device with one or more mechanical linkages to prevent the shutter device and the chamber access device from being simultaneously opened.

34. The method of claim 27 wherein said interfacing the shutter device and the chamber access device includes electrically interfacing the shutter device and the chamber access device with one or more solenoid devices to prevent the shutter device and the chamber access device from being simultaneously opened.
